(19) United States
(12) Patent Application Publication
(10) Pub. No.: US 2026/0163797 A1
(43) Pub. Date: Jun. 11, 2026

(54) SYSTEM AND METHOD FOR LOCATION-BASED NETWORK ANALYSIS USING SPATIAL DATA MODELS

(71) Applicant: VERIZON PATENT AND LICENSING INC., Basking Ridge, NJ (US)

(72) Inventor: Corey J. CHRISTOPHERSON, Bainbridge Island, WA (US)

(73) Assignee: VERIZON PATENT AND LICENSING INC., Basking Ridge, NJ (US)

(21) Appl. No.: 18/971,145

(22) Filed: Dec. 6, 2024

(51) Int. Cl. H04L 41/0823; H04L 41/14

(52) U.S. Cl. CPC H04L 41/0823; H04L 41/14

(57) ABSTRACT

A device may receive location data identifying a geographic location. The device may generate, based on the location data, a plurality of spatial regions including a primary spatial region centered on the geographic location and a set of surrounding spatial regions adjacent to the primary spatial region. The device may retrieve network measurement data collected within the plurality of spatial regions, and may generate, for each spatial region, a statistical distribution representing network conditions based on the network measurement data within that spatial region. The device may analyze relationships between the statistical distributions of adjacent spatial regions to determine spatial variations in network conditions, and may adjust network equipment configurations based on the relationships to improve network performance in regions where the statistical distributions indicate degraded network conditions.

### BACKGROUND

Wireless networks, such as cellular networks, provide communication services to devices across geographic areas through radio frequency transmission between network equipment and user devices. These networks can collect operational data including signal measurements, connection statistics, and performance metrics from both network equipment and user devices. The collected data can include various radio frequency measurements, timing measurements, and other operational parameters that characterize network conditions at different locations. This operational data can be used for multiple purposes including network planning, optimization, and service qualification.

### BRIEF DESCRIPTION OF THE DRAWINGS

FIG. 1 is a flow diagram illustrating a method for analyzing network conditions using spatial data models according to some of the disclosed embodiments.

FIG. 2 is a diagram illustrating an example of dynamic spatial binning, including a center region and surrounding regions at different resolutions according to some of the disclosed embodiments.

FIG. 3 is a flow diagram illustrating a method for generating and using statistical distributions from measurement data within spatial regions according to some of the disclosed embodiments.

FIG. 4 is a block diagram illustrating a system for implementing the spatial data modeling and analysis methods according to some of the disclosed embodiments.

FIG. 5 is a block diagram illustrating a computing device.

### DETAILED DESCRIPTION

Traditional radio frequency (RF) propagation modeling often become increasingly inaccurate at higher frequencies, particularly in millimeter wave (mmWave) bands, due to physical limitations in modeling signal interactions with physical structures and environmental factors. As wavelengths decrease, smaller objects and surface features significantly impact signal propagation, making it difficult to accurately predict network coverage and performance using conventional clutter-based propagation models. This creates particular challenges for mmWave fixed wireless access (FWA) service qualification, where accurate prediction of service quality at specific locations is critical.

The present disclosure describes systems and methods that processes network measurement data using a dynamic spatial binning approach combined with statistical modeling. In some of the described implementations, the system divides geographic areas into adjustable polygonal regions centered on locations of interest, with surrounding regions providing directional context. Each region aggregates actual network measurements from user equipment (UE) operating within its bounds. The system processes these measurements to create statistical distributions representing network conditions and determines relationships between adjacent regions to characterize signal propagation patterns.

This approach addresses the limitations of traditional propagation modeling by creating a data-driven representation of actual network conditions. Rather than relying on theoretical models of signal behavior, the system can use measured data to characterize both the expected network conditions at specific locations and the spatial variation of these conditions. Using a statistical framework enables quantification of uncertainty in these characterizations and supports both direct analysis and machine learning applications. By processing measurement data in this spatial framework, the system can predict service quality with higher accuracy than traditional propagation modeling, particularly for higher frequency bands where conventional models are less reliable.

Conventional RF propagation models rely on pre-defined signal loss calculations based on estimated physical characteristics of structures and terrain. These models become computationally intensive and less accurate when attempting to account for the numerous small-scale features that affect higher frequency signals. The present system overcomes these limitations by creating location-specific statistical models derived directly from operational measurements. By aggregating measurements within dynamically-sized spatial regions, the system can automatically capture the cumulative effects of all environmental factors affecting signal propagation, without requiring explicit modeling of individual structures or surfaces. The system's ability to adjust spatial resolution based on data density and environmental complexity enables efficient processing while maintaining statistical significance. Furthermore, by analyzing relationships between adjacent regions, the system can classify directional signal propagation patterns without requiring detailed electromagnetic simulations, providing an improved computationally efficient method for determining optimal device placement and predicting service quality.

The described methods enable network analysis and optimization using spatial data modeling. In some implementations, the method involves receiving location data for a target geographic area and generating multiple spatial regions around it: a primary region centered on the location surrounded by adjacent regions. Network measurement data is collected from these regions and processed to create statistical distributions representing network conditions in each area. By analyzing relationships between these distributions across adjacent regions, the method can identify variations in network conditions and adjust equipment configurations to improve performance where degraded conditions are detected.

The spatial regions are generated with consideration of resolution, taking into account both the density of available measurement data and the complexity of physical structures in the area. The statistical analysis involves resampling the measurement data to create normalized distributions and calculating key parameters, such as central tendency and dispersion measures. The relationships between regions are analyzed by comparing these distribution parameters to identify gradients in network conditions and understand how conditions propagate across space.

The method incorporates confidence calculations based on data volume and temporal distribution and includes sophisticated data retrieval using spatial indices and filtering capabilities. The analysis can generate various outputs including network condition predictions, equipment orientation recommendations, and service qualification decisions.

This method can be implemented as computer program instructions stored on a non-transitory computer-readable storage medium. When executed by a processor, these instructions enable a computing system to perform the spatial analysis and network optimization steps. The method can also be implemented in a device comprising a processor and memory storing instructions that, when executed, cause the processor to perform the described steps. The implementation can leverage parallel processing capabilities and distributed computing resources to handle large-scale network data analysis efficiently.

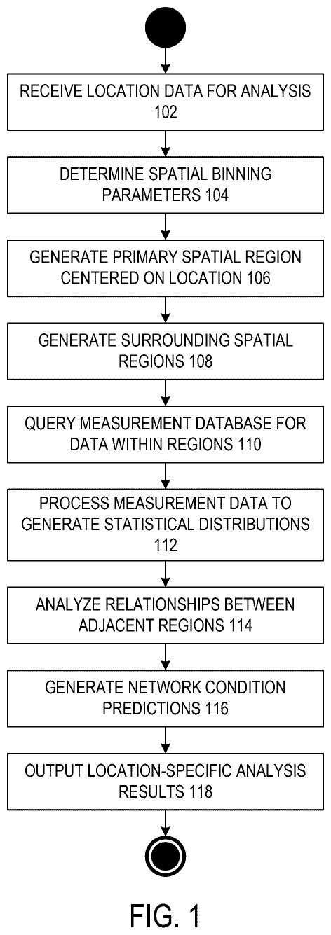

FIG. 1 is a flow diagram illustrating a method for analyzing network conditions using spatial data models.

In step 102, the method can include receiving location data for analysis.

In some implementations, the location data may include geographic coordinates such as latitude and longitude, a street address, or other geographic identifiers that can be converted to specific coordinates. In some implementations, the location data may also include additional parameters such as building type, structure height, or other environmental factors that may influence the selection of analysis parameters in subsequent steps. In some implementations, the location data serves as the central point around which the spatial analysis will be performed.

In step 104, the method can include determining spatial binning parameters based on the received location data.

In some implementations, these parameters can define how the geographic space around the location will be divided into discrete regions for analysis. In some implementations, the determination of spatial binning parameters can include selecting an appropriate resolution or size for the spatial regions based on multiple factors. In some implementations, these factors may include the density of available measurement data, the complexity of the surrounding environment, and the type of analysis being performed. For example, in areas with complex urban environments, smaller spatial regions can be selected to capture fine-grained variations in network conditions, while larger regions can be appropriate in open areas where conditions vary more gradually.

In step 106, the method can include generating a primary spatial region centered on the received location.

In some implementations, the primary spatial region can represent the immediate area around the location of interest and serves as the focal point for the analysis. In some implementations, the size and shape of the primary spatial region can be determined by the spatial binning parameters selected in step 104. In some implementations, while various geometric shapes may be used for the spatial regions, regular polygons that can be tessellated (such as hexagons or squares) may be used as they allow for consistent analysis of relationships between adjacent regions.

In some implementations, the system can implement specialized data structures optimized for spatial-temporal queries and statistical analysis. In some implementations, the primary spatial index can use a hierarchical structure based on recursive subdivision of hexagonal regions. In some implementations, each spatial region can be represented by a data structure that can contain a region identifier and geometric properties, statistical summary data including pre-computed distribution parameters, a measurement metadata index, adjacent region references, resolution level indicators, temporal index structures, etc. In some implementations, this data structure can enable efficient access to both raw measurements and derived statistical properties while maintaining the spatial relationships necessary for regional analysis.

In step 108, the method can include generating surrounding spatial regions adjacent to the primary spatial region.

In some implementations, these surrounding regions can form a complete ring or layer around the primary region and are used to analyze spatial variations in network conditions. In some implementations, the surrounding regions can be generated at the same resolution as the primary region or at different resolutions depending on the analysis requirements. In some implementations, multiple rings of surrounding regions can be generated, with outer rings potentially using larger regions to efficiently cover more distant areas while maintaining computational efficiency.

In step 110, the method can query a measurement database to retrieve network measurement data within the generated spatial regions.

In some implementations, the measurement data can include various network metrics collected from user equipment operating within the regions, such as signal strength measurements, throughput measurements, connection quality indicators, and other relevant network performance metrics. In some implementations, the query may include temporal parameters to restrict the data to relevant time periods and may apply initial filtering criteria to exclude invalid or irrelevant measurements.

In some implementations, the system can maintain measurement data in a hybrid storage architecture that can combine the benefits of columnar storage for efficient statistical computations with spatial indexing for location-based queries. In some implementations, the architecture can implement a multi-level caching system that can provide graduated access to data based on frequency of use and computational requirements. In some implementations, at the highest level, an in-memory cache can maintain frequently accessed region statistics for immediate access. In some implementations, a second level cache can maintain measurement summaries for active analysis regions, while the third level can store full measurement data in compressed columnar format for efficient storage and retrieval.

In some implementations, query optimization can employ both spatial and temporal pruning techniques to minimize data access requirements and processing overhead. In some implementations, spatial queries can use a hierarchical filtering approach that can begin with initial filtering using a coarse-resolution spatial index, followed by refined filtering using precise region boundaries, and concluding with final filtering that can incorporate temporal constraints. In some implementations, this graduated approach can ensure that the system minimizes unnecessary data access while maintaining query accuracy.

In step 112, the method can include processing the retrieved measurement data to generate statistical distributions for each spatial region.

In some implementations, this processing can include aggregating measurements within each region and generating statistical representations of the network conditions. In some implementations, the statistical distributions can be generated for multiple network metrics independently. For example, separate distributions can be generated for signal strength, throughput, and other performance indicators. In some implementations, the processing can include techniques such as resampling to normalize non-normal distributions and the calculation of various statistical parameters such as means, variances, and confidence intervals.

In some implementations, the system can implement parallel processing through a task partitioning scheme that can balance computational load while minimizing cross-partition data dependencies. In some implementations, statistical computations can be distributed across processing units based on spatial proximity, which can reduce inter-process communication requirements. In some implementations, this approach can enable efficient scaling of computational resources while maintaining the spatial relationships necessary for accurate analysis.

In some implementations, memory management can implement a region-based allocation strategy where spatially proximate data can be stored in contiguous memory blocks when possible. In some implementations, this approach can improve cache utilization during spatial analysis operations by maximizing spatial locality in memory access patterns. In some implementations, the system can implement adaptive memory management that can adjust the balance between in-memory and disk-based storage based on available system resources and analysis requirements, which can ensure efficient operation across varying hardware configurations.

In some implementations, for distributed deployments, the system can implement a data partitioning scheme that can maintain spatial locality while enabling parallel processing. In some implementations, the partitioning algorithm can create primary partitions based on geographic boundaries while maintaining overlap regions to enable independent processing. In some implementations, the system can implement distributed caching with locality awareness and can provide mechanisms for partition rebalancing based on workload, which can ensure efficient operation in distributed computing environments.

In some implementations, computational efficiency can be optimized through several techniques that can minimize processing overhead while maintaining analysis accuracy. In some implementations, the system can implement incremental updates of statistical parameters when new measurements arrive, which can avoid full recomputation when possible. In some implementations, derived metrics can be computed lazily, only when explicitly requested, which can reduce unnecessary computation. In some implementations, the system can maintain a cache of intermediate results for common analysis paths, which can improve response time for frequently requested analyses. In some implementations, the system can implement adaptive precision in numerical computations based on requirements, which can ensure computational resources are used efficiently while maintaining necessary accuracy levels.

In step 114, the method can include analyzing relationships between adjacent regions to characterize spatial variations in network conditions.

In some implementations, this analysis can include comparing the statistical distributions of corresponding metrics between neighboring regions to identify patterns and trends in how network conditions vary across space. In some implementations, the analysis can include calculating gradients or rates of change between regions, identifying directional patterns in network metrics, and determining the statistical significance of observed variations. In some implementations, this step is particularly important for understanding how network conditions propagate through space and for identifying optimal directions or positions for network equipment placement.

In step 116, the method can include generating network condition predictions based on the statistical distributions and spatial relationships analyzed in previous steps.

In some implementations, these predictions may include expected values for various network metrics at the location of interest, confidence intervals for these predictions, and directional information indicating how network conditions vary in different directions from the location. In some implementations, the predictions can take into account both the direct measurements within the primary region and the spatial patterns identified through analysis of surrounding regions.

In some implementations, the method can implement specialized processing pipelines optimized for different network analysis scenarios. In some implementations, each pipeline can adapt the core statistical framework to address specific operational requirements while maintaining consistency in the underlying statistical approach. In some implementations, these adaptations can enable the method to handle the unique characteristics of different deployment environments while providing reliable analysis results.

In some implementations, in urban environments for example, the method can employ enhanced spatial resolution to capture the effects of dense building structures. In some implementations, the statistical processing can incorporate building height and density metrics, material-specific signal attenuation factors, and can account for complex multi-path reflection patterns. In some implementations, the method can analyze street canyon effects that can significantly impact signal propagation in dense urban areas. In some implementations, the urban analysis pipeline can implement a ray-tracing inspired statistical approach that can analyze measurement patterns along street corridors and between buildings. In some implementations, by identifying dominant signal paths through correlation patterns in signal strength measurements across adjacent regions, the method can enable optimization of device placement in complex urban geometries.

In some implementations, for rural environments for example, the method can adapt its processing methods to handle sparse measurement data while maintaining prediction accuracy. In some implementations, the processing pipeline can implement extended spatial correlation analysis across larger regions, combining this with terrain-aware statistical aggregation. In some implementations, the method can dynamically adjust its resolution selection based on land use patterns, which can ensure that sufficient measurements are included in each analysis region while preserving meaningful spatial differentiation. In some implementations, enhanced outlier detection methods specifically designed for sparse datasets can help maintain data quality without unnecessarily discarding valid measurements that might appear anomalous in more dense urban environments.

In some implementations, frequency-specific analysis can require further adaptation of the processing methods based on the characteristics of different frequency bands. In some implementations, for millimeter wave bands for example, the system can increase spatial resolution near atmospheric absorption features and can enhance its processing of rapid signal strength variations. In some implementations, the statistical modeling can incorporate weather-dependent effects and can implement fine-grained analysis of obstruction impacts. In some implementations, lower frequency bands can allow for broader spatial aggregation with emphasis on large-scale propagation patterns. In some implementations, the system can adapt its statistical modeling to account for seasonal foliage effects and can analyze ground reflection patterns that can become more significant at lower frequencies.

In some implementations, service qualification decisions can employ a multi-stage analysis process that can begin with a primary analysis phase calculating service reliability probability distributions and analyzing the temporal stability of network metrics. In some implementations, the system can evaluate the directional dependence of service quality and can generate confidence bounds for performance predictions. In some implementations, this can be followed by a validation phase that can cross-validate predictions against known service outcomes and can analyze prediction error patterns. In some implementations, the validation results can feed back into the statistical models, which can allow for continuous refinement of prediction accuracy and adjustment of confidence intervals based on operational experience.

In some implementations, device placement optimization can implement specialized processing that can generate three-dimensional statistical surfaces of predicted performance. In some implementations, the system can analyze gradient patterns in network metrics to identify local maxima in service quality predictions while evaluating the stability of performance predictions across varying weather conditions. In some implementations, the placement optimization can incorporate uncertainty analysis through Monte Carlo simulation of performance variations and sensitivity analysis of placement parameters. In some implementations, this comprehensive approach can enable statistical evaluation of alternative placement options and can generate confidence scores for placement recommendations, which can provide network planners with quantitative measures to support deployment decisions.

In step 118, the method outputs location-specific analysis results.

In some implementations, these outputs can include various forms of information derived from the analysis, such as predicted values for network metrics at the location of interest, confidence intervals or uncertainty measures for the predictions, directional information indicating optimal orientations for equipment placement, recommendations for network equipment configuration, visualizations of spatial variations in network conditions, statistical summaries of network conditions in the area,

In some implementations, the output format can be tailored to specific use cases, such as service qualification assessment, network planning, or optimization activities.

In some implementations, the method can also include additional steps for validating the predictions against known measurements or refining the analysis based on feedback. In some implementations, the method can be implemented as part of a larger system for network planning and optimization, with the outputs being used to inform various network management decisions.

The method illustrated in FIG. 1 provides several technical advantages over traditional approaches. By processing actual measurement data within a structured spatial framework, the method captures the real-world effects of environmental factors on network conditions without requiring explicit modeling of these factors. The statistical approach enables quantification of uncertainty in the predictions and supports data-driven decision-making. The spatial analysis of relationships between regions provides insights into directional variations that can be used to optimize network equipment placement and configuration. It is to be understood, that the steps described with respect to FIG. 1 may be combined into or broken up into single or multiple steps, may be processed in different orders, may be omitted or additional steps may be added.

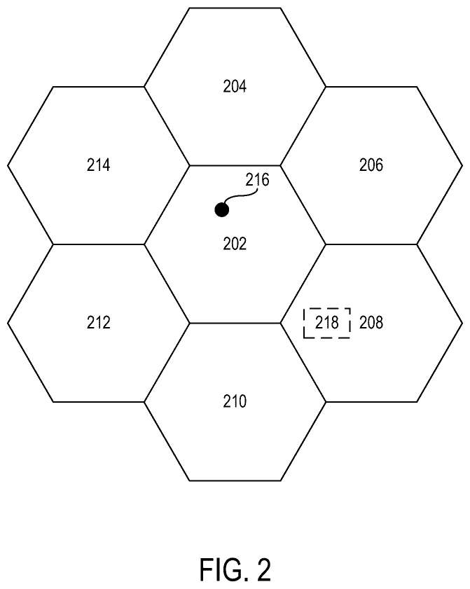

FIG. 2 is a diagram illustrating an example of dynamic spatial binning, including a center region and surrounding regions at different resolutions according to some of the disclosed embodiments.

The illustrated figure depicts a two-dimensional representation of spatial regions centered on a location of interest, demonstrating the relationship between different regions and their relative positions.

As illustrated, the primary spatial region 202 is positioned at the center of the arrangement and may represent the location of interest, as discussed above. This region serves as the focal point for the analysis and is typically sized to encompass an area appropriate for the specific analysis being performed. For example, the primary region may be sized to contain a building, a portion of a street, or another area of interest. The primary spatial region 202 is depicted as a regular hexagon, though other regular polygonal shapes capable of tessellation may be used in different implementations.

Surrounding the primary spatial region 202 are six adjacent regions 204, 206, 208, 210, 212, and 214, forming a ring around the primary region. Each of these surrounding regions shares an edge with the primary region and with two other surrounding regions. The surrounding regions may be the same size as the primary region, or they may be of different sizes depending on the analysis requirements. In this example, regions 204, 206, 208, 210, 212, and 214 are shown as regular hexagons of equal size to the primary region, creating a uniform tessellation of the space.

Location marker 216 may indicate a specific point of interest within the primary spatial region 202, such as a street address or set of coordinates for which network conditions are being analyzed. The location marker may represent, for example, the position where network equipment is to be installed or where service quality needs to be assessed.

Region 218 illustrates an example of a finer resolution spatial bin that may be used in areas requiring more detailed analysis. This smaller region demonstrates how the spatial binning resolution can be adjusted to match the granularity requirements of different areas or analysis types. For instance, areas with complex environments or dense measurement data may use smaller regions to capture fine-grained variations in network conditions.

The arrangement of regions in FIG. 2 provides several technical advantages. The regular hexagonal shape ensures consistent distances between region centers, unlike square or rectangular bins where diagonal distances differ from orthogonal distances. The surrounding regions provide complete coverage of all directions around the primary region, enabling comprehensive directional analysis. Additionally, the ability to adjust region size, as shown by region 218, allows the analysis to adapt to different environmental conditions and data densities. The tessellated arrangement ensures no gaps or overlaps between regions, maintaining complete coverage of the analysis area.

Each region (204, 206, 208, 210, 212, and 214) serves as a container for measurement data collected within its boundaries. In some implementations, the measurements within each region are processed collectively to generate statistical representations of network conditions in that area. In some implementations, the shared edges between regions enable analysis of how network conditions vary between adjacent areas, supporting the characterization of spatial patterns and trends.

In some implementations, the arrangement may be extended with additional rings of regions around those shown, using either the same or different resolutions. The selection of how many rings to include can depend on factors such as the typical propagation distances of the network signals being analyzed and the density and availability of measurement data. Additional considerations can include computational resources, processing time constraints, and the specific requirements of the analysis being performed.

In some implementations, the spatial binning arrangement illustrated in FIG. 2 provides a framework for organizing and analyzing network measurement data in a way that captures both local conditions and spatial variations. This organization supports efficient querying of measurement data and enables systematic analysis of network conditions across geographic space.

In some implementations, the system can implement a multi-factor adaptive resolution algorithm that determines appropriate spatial binning sizes dynamically. The algorithm can consider both physical and data characteristics through a weighted scoring function, for example:

$$R = min ( {R}_{data} , {R}_{p h y s} ) ,$$

where R_{data} represents the resolution supported by measurement density, and R_{phys} represents the resolution required by physical characteristics. In some implementations, the data-supported resolution R_{data} is determined by f(n, σ, d), where n is the number of measurements in the candidate region, o represents a spatial dispersion of measurements, and d represents the temporal density of measurements. In some implementations, the physical resolution requirement R_{phys} is calculated by g(c, t, f), where c represents clutter density derived from land use data, t represents terrain variability, and f represents a frequency band of interest.

In some implementations, the algorithm can implement resolution transitions between adjacent regions using a smoothing function that prevents abrupt changes in region size. For example, when transitioning between regions of different resolutions, the system can maintain a maximum resolution ratio of 2:1 between adjacent regions, implementing intermediate resolution steps when necessary. This gradual transition ensures consistent statistical analysis across resolution boundaries while maintaining computational efficiency.

In some implementations, the resolution selection process can include feedback mechanisms that adjust region sizes based on the statistical significance of the resulting analysis. When the initial resolution selection yields insufficient statistical confidence (as measured by the width of confidence intervals), the algorithm can automatically adjust the resolution to optimize the trade-off between spatial precision and statistical reliability.

The system also implements resolution adaptation for temporal variations. Different resolution patterns may be applied based on time-of-day or seasonal factors that affect measurement density or network usage patterns. These temporal patterns are stored and used to pre-select appropriate resolutions for future analyses of the same locations during similar time periods.

In some implementations, the system can include special handling for edge cases such as: areas with highly asymmetric measurement distribution, regions spanning distinct environmental boundaries, locations near network coverage boundaries, and areas with significant temporal variations in measurement density. In these cases, the algorithm may implement non-uniform resolution patterns, where different directions from the central region may use different resolutions based on local conditions.

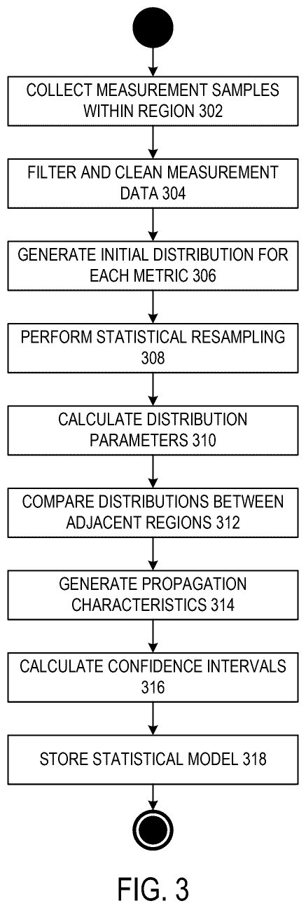

FIG. 3 is a flow diagram illustrating a method for generating and using statistical distributions from measurement data within spatial regions according to some of the disclosed embodiments.

In step 302, the method can include collecting measurement samples within a defined spatial region.

In various implementations, the method can collect measurements samples from multiple UEs operating within the region over various time periods. In some implementations, the measurements can include radio frequency metrics such as signal strength, signal quality indicators, throughput measurements, and other network performance parameters. In some implementations, each measurement can be associated with specific geographic coordinates and a timestamp. In some implementations, the collection process can span multiple frequency bands and network technologies, gathering data that characterizes different aspects of network performance.

In some implementations, the method can handle sparse data regions through a hierarchical approach to statistical inference. For example, when a region contains fewer than a minimum threshold of measurements (typically 30 samples), the method can automatically expand the temporal window for data collection. If this does not yield sufficient samples, the method may implement a spatial borrowing strategy, incorporating weighted measurements from adjacent regions based on their distance from the region of interest. The weights may decay exponentially with distance, ensuring that borrowed measurements appropriately reflect their reduced relevance.

In step 304, the method can include filtering and cleaning the measurement data to prepare it for statistical analysis.

In some implementations, the method can include removing invalid measurements, outliers, and other anomalous data points that could skew the statistical analysis. In some implementations, the filtering criteria may include validity ranges for different metrics, minimum signal strength thresholds, and other quality indicators. In some implementations, the cleaning process can also involve handling missing values, correcting measurement units, and standardizing data formats.

In some implementations, the method can further include detecting and handling measurement anomalies. In some implementations, the method can employ a combination of univariate and multivariate outlier detection methods. For individual metrics, the method can use a modified Z-score approach based on the median absolute deviation, which is more robust to extreme values than traditional Z-scores. For multivariate outlier detection, the method can, for example, calculate the Mahalanobis distance of each measurement from the center of the distribution, using a covariance estimation method to prevent masking effects where clusters of outliers can skew the detection criteria.

In some implementations, when outliers are detected, the method can classify them into three categories: statistical outliers that can be safely removed, systematic deviations that may indicate genuine network issues, and measurement errors that require special handling. In some implementations, this classification can use additional metadata such as measurement timestamps, device types, and concurrent measurements of related metrics. In some implementations, the method can maintain separate statistical models with and without the outliers, allowing for sensitivity analysis of their impact on the final predictions.

In step 306, the method can include generating initial distributions for each metric being analyzed.

In some implementations, these distributions can represent the underlying patterns in the measurement data before any statistical transformation or resampling. In some implementations, the method can generate separate distributions for different network metrics, creating a multidimensional view of network conditions within the region. In some implementations, the initial distributions may exhibit non-normal characteristics, such as multimodal patterns or heavy tails, due to the complex nature of radio frequency propagation and network performance.

In step 308, the method can include performing statistical resampling on the initial distributions.

In some implementations, this step can use techniques such as bootstrap resampling or other statistical sampling methods to generate normalized distributions that are more amenable to statistical analysis. In some implementations, the resampling process can utilize the central limit theorem to create distributions that approximate normal distributions while preserving the essential characteristics of the underlying data. In some implementations, this transformation can enable the application of standard statistical techniques and simplifies the comparison of conditions between different regions.

In some implementations, the resampling process can handle various types of non-normal distributions commonly encountered in network measurements. For signal strength measurements that often exhibit multimodal distributions due to different propagation paths, the method may employ a two-phase bootstrap resampling approach. In the first phase, the method can generate multiple bootstrap samples from the original measurements, with each bootstrap sample containing the same number of measurements as the original dataset. The method can then calculate the mean of each bootstrap sample, creating a distribution of sample means. By the central limit theorem, this distribution of sample means approaches a normal distribution, even when the underlying data is multimodal or heavily skewed.

In some implementations, the comparison of distributions between adjacent regions employs multiple statistical tests selected based on the characteristics of the data. For example, for normally distributed metrics (such as the resampled means), the method can use Welch's t-test to compare means while accounting for potentially different variances. As another example, for metrics that remain non-normal after resampling, the method can employ a Mann-Whitney U test. As another example, the method can combine these test results using Fisher's method to provide a single measure of statistical significance for the difference between regions.

In step 310, the method can include calculating distribution parameters that characterize the resampled data.

In some implementations, these parameters can include measures of central tendency such as means and medians, measures of dispersion such as standard deviations and interquartile ranges, and other statistical moments that describe the shape and properties of the distributions. In some implementations, the parameters can provide a compact representation of the network conditions within each region while capturing the variability and uncertainty in the measurements.

In step 312, the method can include comparing distributions between adjacent regions to identify spatial patterns and relationships.

In some implementations, this comparison can include analyzing how the distribution parameters vary between neighboring regions and characterizing the gradients or transitions in network conditions across space. In some implementations, the comparison may include statistical tests to determine the significance of observed differences and analysis of correlation patterns between adjacent regions.

In step 314, the method can include generating propagation characteristics based on the distribution comparisons.

In some implementations, these characteristics can describe how network conditions change across space and may include parameters such as path loss exponents, spatial correlation coefficients, and directional factors. In some implementations, the propagation characteristics capture both the magnitude and direction of changes in network conditions, providing insights into the underlying physical processes affecting network performance.

In step 316, the method can include calculating confidence intervals for the various statistical parameters and propagation characteristics.

In some implementations, these confidence intervals can quantify the uncertainty in the statistical estimates and provide bounds on the expected network conditions. In some implementations, the calculation of confidence intervals can take into account factors such as sample size, measurement variance, and the statistical properties of the resampled distributions.

In some implementations, confidence intervals can be calculated using a stratified bootstrap approach that accounts for both temporal and spatial variation in the measurements. In some implementations, the method can generate bootstrap samples that maintain the temporal structure of the data, preserving any time-of-day or seasonal patterns. For each bootstrap sample, the method can calculate the parameter of interest (such as mean signal strength or median throughput) and derives empirical confidence intervals from the resulting distribution of parameter estimates. The width of these intervals provides a direct measure of prediction uncertainty that can be used in service qualification decisions.

In step 318, the method can include storing the statistical model containing the distributions, parameters, and confidence intervals.

In some implementations, the stored model can provide a statistical representation of network conditions within and between spatial regions. In some implementations, the model can incorporate the resampled distributions and their parameters, characterizing the expected network conditions and their variability within each region. In some implementations, it can include the propagation characteristics describing how conditions vary between regions, enabling spatial interpolation and prediction. In some implementations, the model can also include the confidence intervals and uncertainty measures.

In the various implementations discussed above, the statistical modeling approach provides several technical advantages over traditional deterministic methods. By working with distributions rather than single-valued estimates, the method can capture the inherent variability in network conditions and provide a framework for quantifying uncertainty. The resampling process can allow for robust statistical analysis even when the underlying data exhibits non-normal characteristics. The comparison of distributions between regions can provides insights into spatial patterns that may not be apparent from individual measurements or simple averages.

In some implementations, the stored statistical model can support multiple analysis functions, including prediction of network conditions at specific locations and analysis of spatial patterns in network performance. It can further enable optimization of network equipment placement and configuration while supporting broader network planning decisions. In some implementations, the model can be updated as new measurements become available, allowing for continuous refinement of the statistical characterization through incorporation of new data points and recalculation of statistical parameters.

The method illustrated in FIG. 3 provides a systematic approach for transforming raw measurement data into actionable statistical insights. By combining spatial analysis with robust statistical methods, the approach enables data-driven decision-making while properly accounting for uncertainty and variability in network conditions. The statistical framework supports both detailed analysis of specific locations and broader understanding of spatial patterns in network performance. It is to be understood that the steps described with respect to FIG. 3 may be combined into or broken up into single or multiple steps, may be processed in different orders, may be omitted, or additional steps may be added to support various implementations of the statistical analysis process.

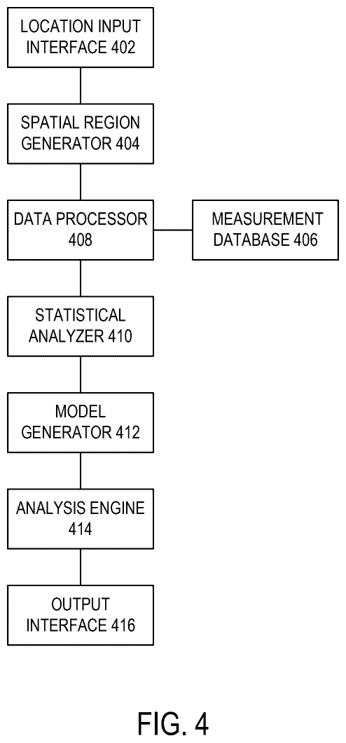

FIG. 4 is a block diagram illustrating a system for implementing the spatial data modeling and analysis methods according to some of the disclosed embodiments.

In the illustrated embodiment, the location input interface 402 serves as the entry point for analysis requests. In some implementations, the location input interface 402 can receive and process location data, which may be provided in various formats such as geographic coordinates, street addresses, or other location identifiers, as discussed previously. In some implementations, the location input interface 402 can include functionality for validating input data and converting between different location reference systems. In some implementations, the location input interface 402 can also receive additional parameters that influence the analysis, such as desired resolution levels, time periods of interest, or specific network metrics to be analyzed. In some implementations, the location input interface 402 can be implemented as an application programming interface (API), a graphical user interface, or both, depending on the system's deployment requirements.

In some implementations, the spatial region generator 404 creates the geometric framework for the analysis based on the location data received through the location input interface. In some implementations, the spatial region generator 404 can implement algorithms for determining appropriate spatial binning parameters and generating the regions that will contain the measurement data. In some implementations, the spatial region generator 404 can include logic for selecting region sizes based on factors such as data density and environmental complexity. In some implementations, the spatial region generator 404, can generate both the primary region centered on the location of interest and the surrounding regions needed for spatial analysis. In some implementations, the spatial region generator 404 can maintain geometric relationships between regions and ensures proper tessellation of the analysis area.

The measurement database 406 stores the network measurement data collected from user equipment operating within the network. In some implementations, the measurement database 406 can be implemented using various database technologies suitable for managing large volumes of geospatial data. In some implementations, the measurement database 406 can maintain indices for efficient spatial queries and includes mechanisms for data retention and archival. In some implementations, the measurement database 406, can store not only the raw measurement values but also metadata such as timestamps, measurement conditions, and data quality indicators. In some implementations, the measurement database 406 may implement partitioning schemes based on geographic areas or time periods to optimize query performance.

The data processor 408 retrieves and conditions the measurement data for analysis. In some implementations, the data processor 408 can interface with the measurement database to execute spatial queries based on the regions defined by the spatial region generator. In some implementations, the data processor 408 can implement the data cleaning and filtering logic necessary to prepare measurements for statistical analysis. In some implementations, the data processor 408 can include mechanisms for handling missing data, removing outliers, and standardizing measurements across different devices or measurement conditions. In some implementations, the data processor 408 can also implement data aggregation functions to manage computational complexity when processing large volumes of measurements.

The statistical analyzer 410 implements the statistical methods used to characterize network conditions within and between spatial regions. In some implementations, the statistical analyzer 410 can process the conditioned measurement data to generate statistical distributions and calculate distribution parameters. In some implementations, the statistical analyzer 410 can implement the resampling algorithms needed to normalize non-normal distributions and includes functions for calculating confidence intervals and other statistical measures. In some implementations, the statistical analyzer 410 can include capabilities for comparing distributions between adjacent regions and identifying spatial patterns in network conditions. In some implementations, the statistical analyzer 410 can implement various statistical tests to assess the significance of observed patterns and relationships.

The model generator 412 creates and maintains the statistical models that represent network conditions across the analysis area. In some implementations, the model generator 412 can combine the outputs from the statistical analyzer with spatial relationship information to create comprehensive models of network behavior. In some implementations, the model generator 412 can implement algorithms for characterizing spatial variations in network conditions and may include machine learning capabilities for pattern recognition and prediction. In some implementations, the model generator 412 can maintain the mathematical relationships needed for interpolation between measured locations and extrapolation to nearby areas.

The analysis engine 414 applies the statistical models to generate specific insights and predictions for locations of interest. In some implementations, the analysis engine 414 can implement the analytical methods needed to extract actionable information from the statistical models. In some implementations, the analysis engine 414 can include capabilities for predicting network conditions at specific locations, analyzing spatial trends, and generating confidence bounds for predictions. In some implementations, the analysis engine 414 can implement various optimization algorithms to support network planning and configuration decisions. In some implementations, the analysis engine 414 can include logic for combining multiple types of analysis to provide comprehensive insights into network conditions.

The output interface 416 formats and delivers the analysis results to system users. In some implementations, the output interface 416 can implement various output formats and visualization capabilities to effectively communicate analysis results. In some implementations, the output interface 416 can generate both human-readable reports and machine-readable data formats suitable for integration with other systems. T In some implementations, the output interface 416 can include mechanisms for providing different levels of detail based on user requirements and may implement caching mechanisms to improve response times for frequently requested analyses.

In some implementations, when a location is submitted through the location input interface 402, the system can initiate a workflow that proceeds through the components in a logical sequence. The spatial region generator 404 can first define the analysis framework, followed by data retrieval and processing through the data processor 408. The statistical analyzer 410 and model generator 412 can then create the mathematical representations needed for analysis, with the analysis engine 414 generating the specific insights requested. Finally, the output interface 416 can deliver the results in appropriate formats.

The system architecture provides several technical advantages. The separation of concerns between components enables independent optimization of different aspects of the analysis process. The system can scale different components based on computational requirements and can be distributed across multiple computing resources if needed. The modular design enables updates to specific components without affecting the entire system, supporting continuous improvement of analytical capabilities.

In some implementations, the system can implement various optimization techniques to maintain performance with large data volumes. For example, the measurement database 406 may implement caching mechanisms for frequently accessed data, while the data processor 408 may employ parallel processing for data conditioning. The statistical analyzer 410 may implement adaptive algorithms that adjust the depth of analysis based on data availability and quality. The analysis engine 414 may cache intermediate results to speed up repeated analyses of similar locations.

Error handling and data quality management can be implemented throughout the system. For example, each component can include validation mechanisms appropriate to its function, ensuring that errors are caught and handled at appropriate points in the workflow. The system can maintain audit trails of analysis requests and results, supporting troubleshooting and system improvement efforts. Components may implement retry mechanisms for handling transient failures and include fallback modes for generating results with degraded data availability.

In some implementations, the system can implement comprehensive error detection and recovery mechanisms throughout its processing pipeline to ensure robust operation under various degraded conditions. In some implementations, these mechanisms can work together to maintain analysis quality while adapting to data quality issues, system resource constraints, and other operational challenges that may arise during normal operation.

In some implementations, the measurement quality control framework can operate across three validation layers, each providing increasingly sophisticated analysis of data quality. In some implementations, the primary validation layer can perform fundamental quality checks including range checking against physical limits, consistency checking across related metrics, temporal continuity validation, and spatial consistency verification. In some implementations, these basic checks can identify obvious measurement errors and data corruption issues before they can impact analysis results. In some implementations, the secondary validation layer can implement more sophisticated validation through cross-metric correlation analysis, device-specific calibration adjustment, environmental condition correlation, and historical pattern matching. In some implementations, this layer can identify subtle measurement issues that may not be apparent from individual metric analysis. In some implementations, the tertiary validation layer can provide system-wide quality control through statistical anomaly detection, trend analysis and deviation detection, system-wide consistency checking, and cross-technology validation, which can ensure that measurements remain consistent across different aspects of network operation.

In some implementations, the system can implement graduated recovery procedures based on error severity, with specific handling mechanisms for different types of data quality issues. In some implementations, when facing data sparsity, the system can employ adaptive temporal window expansion and spatial interpolation with uncertainty quantification. In some implementations, the resolution of analysis regions can be automatically adjusted to maintain statistical significance, while confidence levels can be adjusted based on data availability. In some implementations, this approach can ensure that the system continues to provide meaningful results even with reduced data availability, while clearly indicating the increased uncertainty in its predictions.

In some implementations, measurement anomaly recovery can begin with automated classification of anomaly types, which can allow the system to apply appropriate handling strategies. In some implementations, the system can implement selective measurement filtering based on confidence metrics and can adapt its statistical models to handle anomalous patterns when they are determined to represent actual network behavior rather than measurement errors. In some implementations, uncertainty bounds can be automatically adjusted for affected predictions, which can ensure that the reduced confidence in areas with anomalous measurements is properly reflected in analysis results.

In some implementations, system-level recovery mechanisms can ensure continued operation even under significant resource constraints or component failures. In some implementations, the system can implement graceful degradation of analysis capability, automatically failing over to backup processing paths when necessary. In some implementations, processing resolution can be progressively reduced under resource constraints, while computational resources can be dynamically reallocated to maintain essential analysis functions. In some implementations, these mechanisms can ensure that the system continues to provide useful results even under degraded operating conditions.

In some implementations, quality assurance can be maintained through continuous monitoring of both statistical quality metrics and system health indicators. In some implementations, statistical quality monitoring can include prediction error tracking, confidence interval validation, cross-validation performance monitoring, and temporal stability analysis. In some implementations, system health monitoring can track component performance, resource utilization, error rates, and processing latency. In some implementations, this comprehensive monitoring can enable early detection of developing issues and can support proactive system optimization.

In some implementations, the system can implement automated adjustment mechanisms that can continuously optimize performance based on monitoring results. In some implementations, these mechanisms can include dynamic threshold adaptation, processing parameter optimization, resource allocation adjustment, and model parameter tuning. In some implementations, the error handling framework can provide continuous feedback to the statistical modeling components, which can enable ongoing improvement of prediction accuracy and reliability. In some implementations, a detailed audit trail of error patterns and recovery actions can be maintained, which can support both immediate operational needs and long-term system optimization efforts.

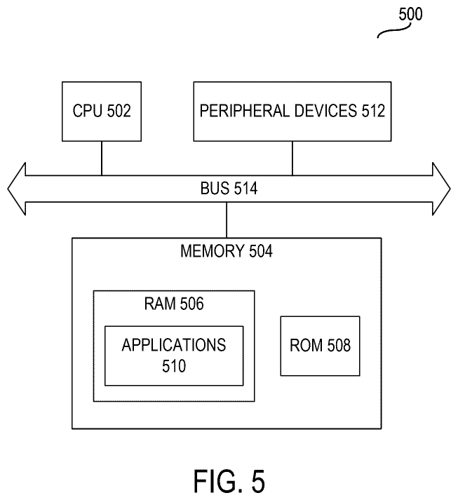

FIG. 5 is a block diagram illustrating a computing device.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving location data identifying a geographic location;
generating, based on the location data, a plurality of spatial regions including a primary spatial region centered on the geographic location and a set of surrounding spatial regions adjacent to the primary spatial region;
retrieving network measurement data collected within the plurality of spatial regions;
generating, for each spatial region, a statistical distribution representing network conditions based on the network measurement data within that spatial region;
analyzing relationships between the statistical distributions of adjacent spatial regions to determine spatial variations in network conditions; and
adjusting network equipment configurations based on the relationships to improve network performance in regions where the statistical distributions indicate degraded network conditions.

2. The method of claim 1, wherein generating the plurality of spatial regions comprises:
determining a spatial resolution for the primary spatial region based on at least one of: a density of available network measurement data near the geographic location, or a complexity of physical structures near the geographic location; and
generating the primary spatial region and surrounding spatial regions according to the spatial resolution.

3. The method of claim 1, wherein generating the statistical distribution for each spatial region comprises:
performing statistical resampling on the network measurement data within the spatial region to generate a normalized distribution; and
calculating distribution parameters including at least one of a measure of central tendency or a measure of dispersion for the normalized distribution.

4. The method of claim 1, wherein analyzing relationships between the statistical distributions comprises:
comparing distribution parameters between adjacent spatial regions to identify gradients in network conditions; and
generating propagation characteristics describing how network conditions change between adjacent spatial regions.

5. The method of claim 1, further comprising:
calculating confidence intervals for the statistical distributions based on at least one of: a volume of network measurement data within each spatial region, or a temporal distribution of the network measurement data within each spatial region.

6. The method of claim 1, wherein retrieving the network measurement data comprises:
querying a measurement database using spatial indices corresponding to the plurality of spatial regions; and
filtering the network measurement data based on at least one of: a time period of interest, a frequency band of interest, or a type of network measurement.

7. The method of claim 1, further comprising:
generating, based on the analyzed relationships between statistical distributions, at least one of: a prediction of network conditions at the geographic location, a recommended orientation for network equipment at the geographic location, or a service qualification decision for the geographic location.

8. A non-transitory computer-readable storage medium for tangibly storing program instructions capable of being executed by a processor, the program instructions defining steps of:
receiving location data identifying a geographic location;
generating, based on the location data, a plurality of spatial regions including a primary spatial region centered on the geographic location and a set of surrounding spatial regions adjacent to the primary spatial region;
retrieving network measurement data collected within the plurality of spatial regions;
generating, for each spatial region, a statistical distribution representing network conditions based on the network measurement data within that spatial region;
analyzing relationships between the statistical distributions of adjacent spatial regions to determine spatial variations in network conditions; and
adjusting network equipment configurations based on the relationships to improve network performance in regions where the statistical distributions indicate degraded network conditions.

9. The non-transitory computer-readable storage medium of claim 8, wherein generating the plurality of spatial regions comprises:
determining a spatial resolution for the primary spatial region based on at least one of: a density of available network measurement data near the geographic location, or a complexity of physical structures near the geographic location; and
generating the primary spatial region and surrounding spatial regions according to the spatial resolution.

10. The non-transitory computer-readable storage medium of claim 8, wherein generating the statistical distribution for each spatial region comprises:
performing statistical resampling on the network measurement data within the spatial region to generate a normalized distribution; and
calculating distribution parameters including at least one of a measure of central tendency or a measure of dispersion for the normalized distribution.

11. The non-transitory computer-readable storage medium of claim 8, wherein analyzing relationships between the statistical distributions comprises:
comparing distribution parameters between adjacent spatial regions to identify gradients in network conditions; and
generating propagation characteristics describing how network conditions change between adjacent spatial regions.

12. The non-transitory computer-readable storage medium of claim 8, the steps further comprising:
calculating confidence intervals for the statistical distributions based on at least one of: a volume of network measurement data within each spatial region, or a temporal distribution of the network measurement data within each spatial region.

13. The non-transitory computer-readable storage medium of claim 8, wherein retrieving the network measurement data comprises:
querying a measurement database using spatial indices corresponding to the plurality of spatial regions; and
filtering the network measurement data based on at least one of: a time period of interest, a frequency band of interest, or a type of network measurement.

14. The non-transitory computer-readable storage medium of claim 8, the steps further comprising:
generating, based on the analyzed relationships between statistical distributions, at least one of: a prediction of network conditions at the geographic location, a recommended orientation for network equipment at the geographic location, or a service qualification decision for the geographic location.

15. A device comprising:
a processor configured to:
receive location data identifying a geographic location;
generate, based on the location data, a plurality of spatial regions including a primary spatial region centered on the geographic location and a set of surrounding spatial regions adjacent to the primary spatial region;
retrieve network measurement data collected within the plurality of spatial regions;
generate, for each spatial region, a statistical distribution representing network conditions based on the network measurement data within that spatial region;
analyze relationships between the statistical distributions of adjacent spatial regions to determine spatial variations in network conditions; and
adjust network equipment configurations based on the relationships to improve network performance in regions where the statistical distributions indicate degraded network conditions.

16. The device of claim 15, wherein generating the plurality of spatial regions comprises:
determining a spatial resolution for the primary spatial region based on at least one of: a density of available network measurement data near the geographic location, or a complexity of physical structures near the geographic location; and
generating the primary spatial region and surrounding spatial regions according to the spatial resolution.

17. The device of claim 15, wherein generating the statistical distribution for each spatial region comprises:
performing statistical resampling on the network measurement data within the spatial region to generate a normalized distribution; and
calculating distribution parameters including at least one of a measure of central tendency or a measure of dispersion for the normalized distribution.

18. The device of claim 15, wherein analyzing relationships between the statistical distributions comprises:
comparing distribution parameters between adjacent spatial regions to identify gradients in network conditions; and
generating propagation characteristics describing how network conditions change between adjacent spatial regions.

19. The device of claim 15, the processor further configured to:
calculate confidence intervals for the statistical distributions based on at least one of: a volume of network measurement data within each spatial region, or a temporal distribution of the network measurement data within each spatial region.

20. The device of claim 15, wherein retrieving the network measurement data comprises:
querying a measurement database using spatial indices corresponding to the plurality of spatial regions; and
filtering the network measurement data based on at least one of: a time period of interest, a frequency band of interest, or a type of network measurement.
